(19) United States
(12) Patent Application Publication
(10) Pub. No.: US 2014/0313512 A1
(43) Pub. Date: Oct. 23, 2014

(54) Light Source Quality Evaluating Method by Using Spectral Resemblance With Respect to the Blackbody Radiation

(71) Applicant: National Tsing Hua University, Hsinchu (TW)

(72) Inventors: Jwo-Huei Jou, Hsinchu (TW); Chun-Ju Tseng, Hsinchu (TW); Fu-Chin Yang, Hsinchu (TW)

(21) Appl. No.: 14/036,429

(22) Filed: Sep. 25, 2013

(30) Foreign Application Priority Data
Apr. 17, 2013 (TW) 102113559

(51) Int. Cl. G01J 3/46

(52) U.S. Cl. CPC G01J 3/46
USPC 356/402

(57) ABSTRACT

The present invention relates to a light source quality evaluating method by using spectral resemblance with respect to the blackbody radiation, which mainly comprises 5 method steps. This method is used for evaluating the quality of light based on physiological perception of human. In evaluating operation, the method firstly transfers a power spectrum of a light source to a luminance spectrum of light source through a luminosity function. Next, the method compares the luminance spectrum of light source with a luminance spectrum of the blackbody radiation thereof. Therefore, an index of spectral resemblance with respect to the black body radiation (SR_{BR}) would be calculated and then obtained, such that the SR_{BR} can be used for evaluating the quality of the light source. Moreover, comparing to conventional color rendering index (CRI), SR_{BR} is a better light source quality evaluating method because of having fairness and consistency.

### BACKGROUND OF THE INVENTION

1. Field of the Invention

The present invention relates to a method for analyzing and evaluating the quality of a light source, and more particularly to a light source quality evaluating method by using spectral resemblance with respect to the blackbody radiation.

2. Description of the Prior Art

Light is an important find and use in human civilization society; therefore, according to natural light emitted by sun, the ancient people are able to rise with the sunrise and take rest with the sunset. With the advancement of the technologies, the artificial light is developed from bulb to incandescent bulb after the Edison invents the bulb. Moreover, the solid-state lighting (SSL), such as light-emitting diode (LED), organic light-emitting diode (OLED) and polymer light-emitting diode (PLED), the latest lighting technology is further be proposed.

ELI (ergonomic lighting indicator) is a comprehensive evaluating standard for lighting quality. Please refer to FIG. 1, there is shown a degree indicator diagram of the ELI. As shown in FIG. 1, ELI includes 5 indicating indices for evaluating a light source, the indicating indices consists of:

(A) visual performance, including the factors of illumination, color rendering, and contrast;
(B) vista, including the factors of user psychology, visual hierarchy, and building materials;
(C) visual comfort, including the factors of light distribution uniformity, the existence of uncomfortable glare, and light flashes;
(D) vitality, including the factors of impacts on people's psychological and stimulation; and
(E) empowerment, including the factors of individual light modulation, selective lighting scenes and layouts.

Therefore, through above descriptions, it is able to know there have 4 indicating indices of the ELI being correspondent with the physiological perception of human, which are visual performance, vista, vitality, and empowerment. Accordingly, it is able to further understand that the human's physiological perception is very important for the ELI.

However, differing from the ELI, CRI (color rendering index) is used for evaluating the light quality by distinct way. The method for measuring the CRI of a light source includes the steps of: Firstly, making a light source to illuminate an object for facilitating the object reveals its object color; next, making a reference light source to illuminate the object for facilitating the object reveals a reference object color. Eventually, quantitatively comparing the object color with the reference object color according to 8 color samples of DIN 6169, therefore the CRI of the light source can be obtained.

Through the method steps for measuring the CRI of the light source, it is able to know that the primary step is comparing the object color with the reference object color according to 8 color samples of DIN 6169; obviously, the CRI-measuring steps does not concern or refer human's physiological perception. Based on this reason, predictably, the light source having high CRI value may not show good ELI values on visual performance, vista, vitality, and empowerment. It means that CRI may not be the best index for light source quality because of lacking fairness and consistency.

Accordingly, in view of the CRI may not be the best index for light source quality, the inventor of the present application has made great efforts to make inventive research thereon and eventually provided a light source quality evaluating method by using spectral resemblance with respect to the blackbody radiation.

### SUMMARY OF THE INVENTION

The primary objective of the present invention is to provide a light source quality evaluating method by using spectral resemblance with respect to the blackbody radiation. This method is used for evaluating the quality of light based on physiological perception of human. In evaluating operation, the method firstly transfers a power spectrum of a light source to a luminance spectrum of light source through a luminosity function. Next, the method compares the luminance spectrum of the light source with a luminance spectrum of the blackbody radiation thereof. Therefore, an index of spectral resemblance with respect to the black body radiation (SR_{BR}) would be calculated and then obtained, such that the SRBR can be used for evaluating the quality of the light source. Moreover, comparing to conventional color rendering index (CRI), SR_{BR} is a better light source quality evaluating method because of having fairness and consistency.

Accordingly, to achieve the primary objective of the present invention, the inventor of the present invention provides a light source quality evaluating method by using spectral resemblance with respect to the blackbody radiation, comprising the steps of:

(1) measuring a spectrum and a color temperature of a light;
(2) calculating a corresponding luminance spectrum of blackbody radiation according to the color temperature;
(3) providing a luminosity function;
(4) multiplying the spectrum measured in the step (1) by the luminosity function, so as to transform the spectrum to a luminance spectrum of the light; and
(5) comparing the luminance spectrum of the light with the corresponding luminance spectrum of blackbody radiation, so as to obtain an index of spectral resemblance with respect to the blackbody-radiation (SR_{BR}).

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein::

FIG. 1 is a degree indicator diagram of the ELI;

FIG. 2 is a flow chart of the light source quality evaluating method by using spectral resemblance with respect to the blackbody radiation according to the present invention;

FIG. 3 is a detained flow chart of step (S03);

FIG. 4 is a detained flow chart of step (S04);

FIG. 5 is a power spectrum plot of different light sources;

FIG. 6 is a diagram of a luminosity function;

FIGS. 7A, 7B, 7C, and 7D are schematic diagrams of transforming the power spectrum to the luminance spectrum of incandescent bulb, HPS lamp, fluorescent tube, and LED device, respectively;

FIG. 8 is schematic comparison diagrams of luminance spectrum of incandescent bulb, HPS lamp, fluorescent tube, and LED device and the corresponding luminance spectrum of blackbody radiation thereof; and

FIG. 9 is a statistical table of the SR_{BR} of the incandescent bulb, the HPS lamp, the fluorescent tube, and the LED device.

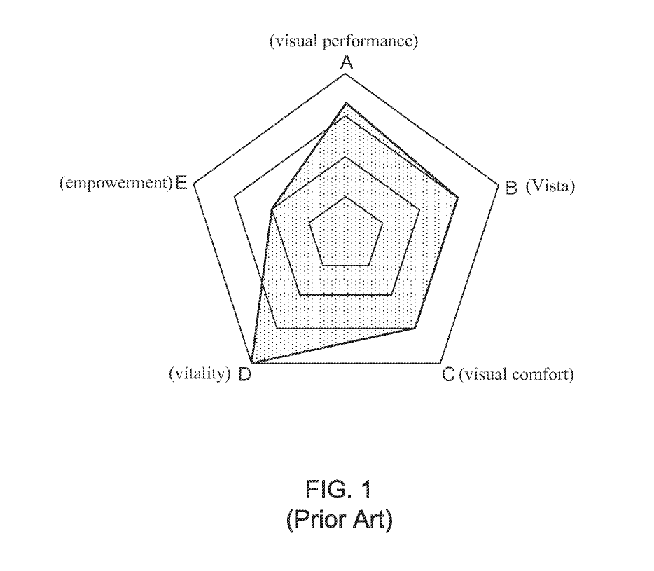

### DETAILED DESCRIPTION OF THE PREFERRED EMBODIMENTS

To more clearly describe a light source quality evaluating method by using spectral resemblance with respect to the blackbody radiation according to the present invention, embodiments of the present invention will be described in detail with reference to the attached drawings hereinafter.

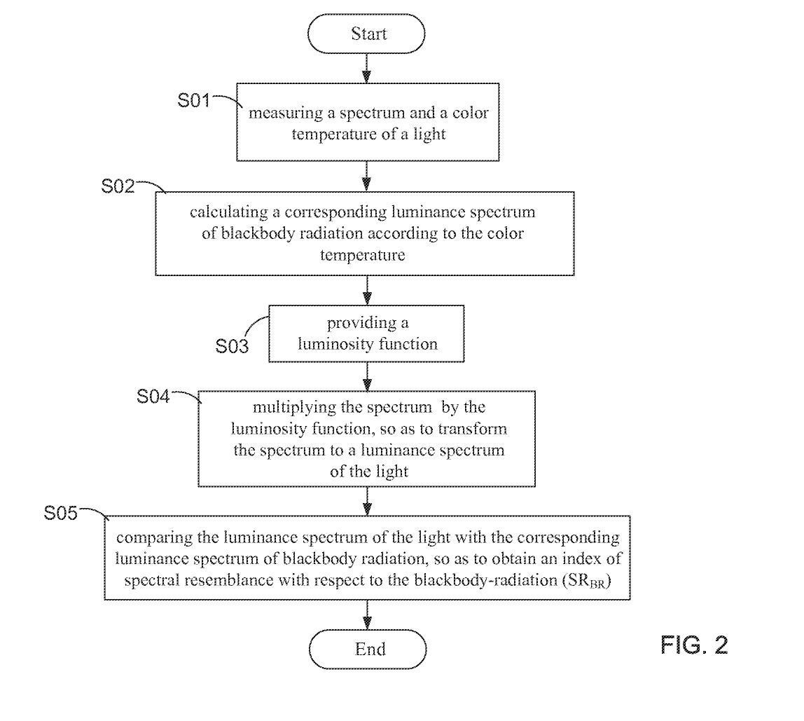

The light source quality evaluating method by using spectral resemblance with respect to the blackbody radiation of the present invention is used for analyzing and evaluating the quality of lights emitted by various lighting devices, such as incandescent bulb, high pressure sodium (HPS) lamp, fluorescent lamp, light-emitting diode (LED) device, organic light-emitting diode (OLED) device, polymer light-emitting diode (PLED) lamp, and candle. Please refer to FIG. 2, which illustrates a flow chart of the light source quality evaluating method by using spectral resemblance with respect to the blackbody radiation according to the present invention. As shown in FIG. 2, the method mainly includes 5 steps.

Firstly, the method is proceeded to step (S01), measuring a spectrum and a color temperature of a light. Next, step (S02) is executed for calculating a corresponding luminance spectrum of blackbody radiation according to the color temperature. Herein, it needs to further explain that the mathematical form of the power spectrum is I(λ, T), and the mathematical form of the luminance spectrum of blackbody radiation is L_{BR}(λ, T)dλ. Moreover, the luminance spectrum of blackbody radiation is calculated by using the Planck's law, wherein the format of the Planck's law is I_{BR}(λ, T)=(2hc²/λ⁵)/[1/(e^{(he/λkT)}−1]. In the format, h means a Planck constant, c means a speed of light, k means a Boltzmann constant, and T means a color temperature. After the step (S02) is finished, the method is continuously proceeded to step (S03).

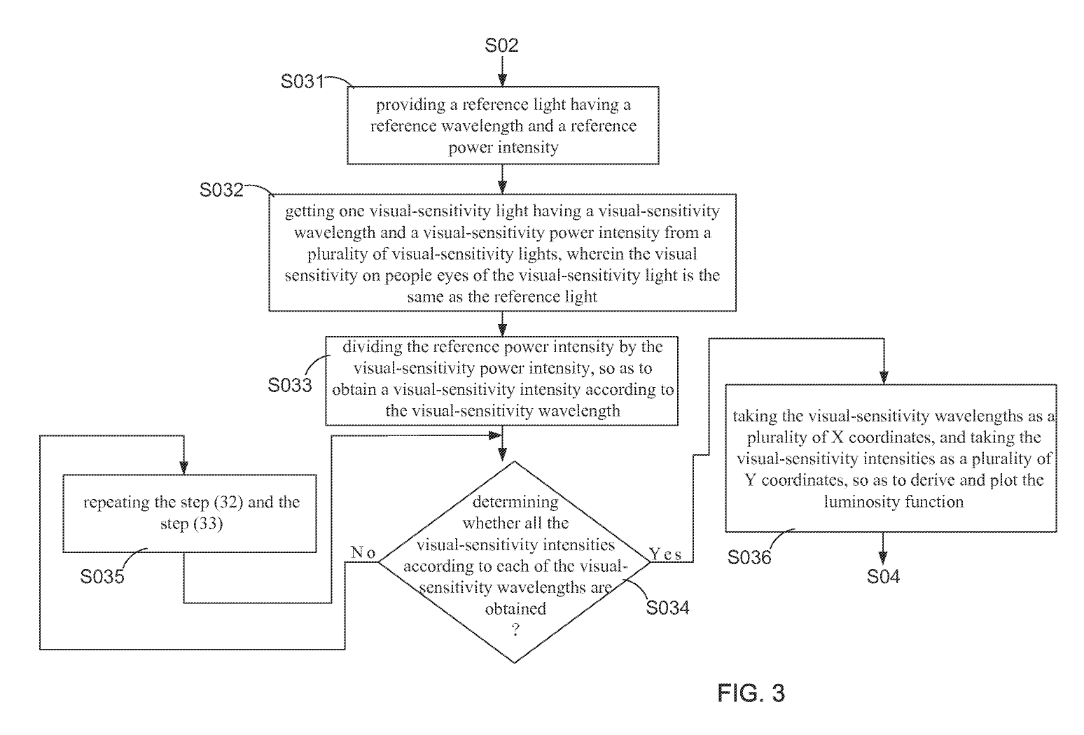

Referring to FIG. 2 again, and please simultaneously refer to FIG. 3, which illustrates a detained flow chart of the step (S03). As shown in FIG. 3, the step (S03) includes 6 detailed steps.

Firstly, step (S031) is executed for providing a reference light having a reference wavelength and a reference power intensity. Next, the method is proceeded to step (S032), so as to get one visual-sensitivity light having a visual-sensitivity wavelength and a visual-sensitivity power intensity from a plurality of visual-sensitivity lights, wherein the visual sensitivity on people eyes of the visual-sensitivity light is the same as the reference light. Sequentially, step (S033) is executed for dividing the reference power intensity by the visual-sensitivity power intensity, so as to obtain a visual-sensitivity intensity according to the visual-sensitivity wavelength. For instance, a visual-sensitivity light having the visual-sensitivity power intensity of 2.5 w and the visual-sensitivity wavelength of 400 nm induces a specific visual sensitivity on people eyes the same as a green light (i.e., the reference light) with the reference power intensity of 1 mw and the reference wavelength of 555 nm. Therefore, the visual-sensitivity intensity of 0.0004 can be calculated by the format of (1 mW/2.5 W).

After completing the step (S033), the method is proceeded to step (S034), so as to determine whether all the visual-sensitivity intensities according to each of the visual-sensitivity wavelengths are obtained, if yes, proceeding to step (S036) for taking the visual-sensitivity wavelengths as a plurality of X coordinates, and taking the visual-sensitivity intensities as a plurality of Y coordinates, so as to derive and plot the luminosity function with the mathematical form of V(λ, T). However, if the determining result is “no”, step (S035) would be executed for repeating the step (S032) and the step (S033).

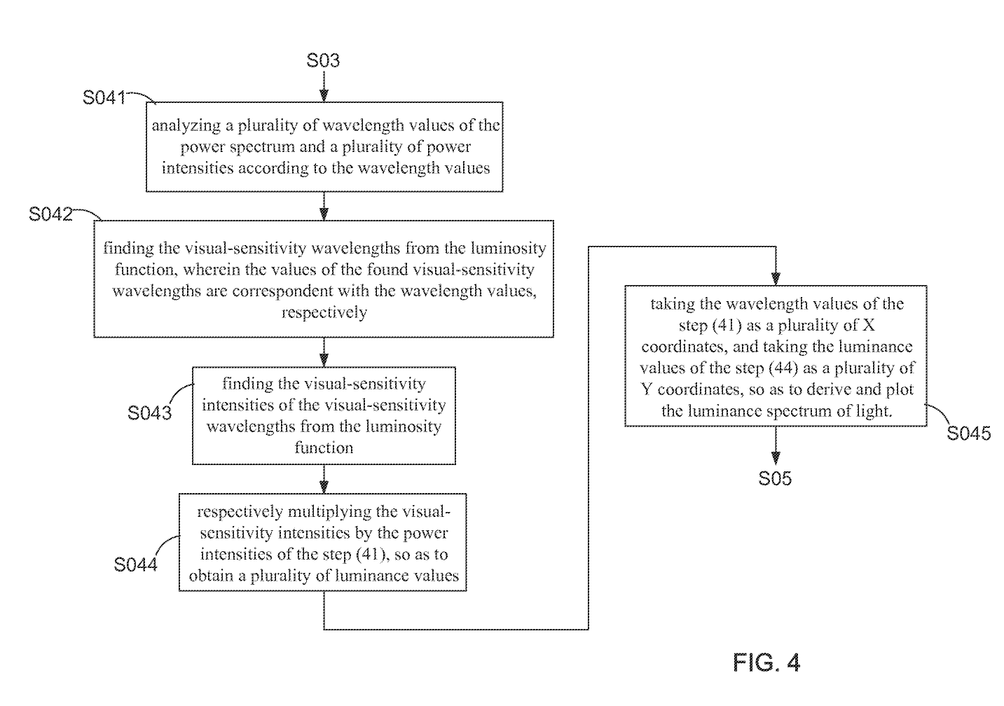

After the step (S03) is finished, the method is continuously proceeded to step (S04), so as to multiply the spectrum measured in the step (S01) by the luminosity function, so as to transform the spectrum to a luminance spectrum of the light. Please refer to FIG. 4, which illustrate a detailed flow chart of the step (S04). As shown in FIG. 4, the step (S04) includes 5 detailed steps.

Firstly, step (S041) is executed for analyzing a plurality of wavelength values of the power spectrum and a plurality of power intensities according to the wavelength values. Next, the method is proceeded to step (S042), so as to find the visual-sensitivity wavelengths from the luminosity function, wherein the values of the found visual-sensitivity wavelengths are correspondent with the wavelength values, respectively. Sequentially, step (S043) is executed for finding the visual-sensitivity intensities of the visual-sensitivity wavelengths from the luminosity function. Then, the method is proceeded to step (S044), so as to respectively multiply the visual-sensitivity intensities by the power intensities of the step (S041), such that a plurality of luminance values are obtained. Eventually, step (S045) is executed for taking the wavelength values of the step (S041) as a plurality of X coordinates, and taking the luminance values of the step (S044) as a plurality of Y coordinates, so as to derive and plot the luminance spectrum of light with the mathematical form of L₁(λ, T)=I(λ, T)×V(λ, T).

As shown in FIG. 2, the method is eventually proceeded to step (505), so as to compare the luminance spectrum of the light with the corresponding luminance spectrum of blackbody radiation, and then obtain an index of spectral resemblance with respect to the blackbody-radiation (SR_{BR}), wherein the SB_{BR} can be a new index for evaluating the quality of artificial light sources. To carrying out the step (S05), it firstly overlaps the luminance spectrum of the light with the corresponding luminance spectrum of blackbody radiation, and next calculates an overlapped area between the luminance spectrum of the light and the corresponding luminance spectrum of blackbody radiation. Therefore, the index of spectral resemblance with respect to the blackbody-radiation (SR_{BR}) can be obtained after dividing the overlapped area by the area of the luminance spectrum of blackbody radiation. In mathematics, the step (S05) includes 4 formats of:

SR_{BR}=[(L(λ,T)dλ)/(L_{BR}(λ,T)dλ)]×100% (1)

L(λ,T)=αL₁(λ,T), if L_{BR}(λ,T)>αL₁(λ,T) (2a)

L(λ,T)=L_{BR}(λ,T), if L_{BR}(λ,T)<αL₁(λ,T) (2b)

α=(L_{BR}(λ,T)dλ)/(L₁(λ,T)dλ) (3)

In above-mentioned 4 formats, L_{BR}(λ, T) means the corresponding luminance spectrum of blackbody radiation of the light, L(λ, T) means an overlapped area between the luminance spectrum of the light L₁(λ, T) and the corresponding luminance spectrum of blackbody radiation L_{BR}(λ, T). α means a luminance constant for equalizing the luminance of the luminance spectrum of light L₁(λ, T) and the corresponding luminance spectrum of blackbody radiation L_{BR}(λ, T), such that the comparison of the luminance spectrum of light and the corresponding luminance spectrum of blackbody radiation can be executed an identical luminance.

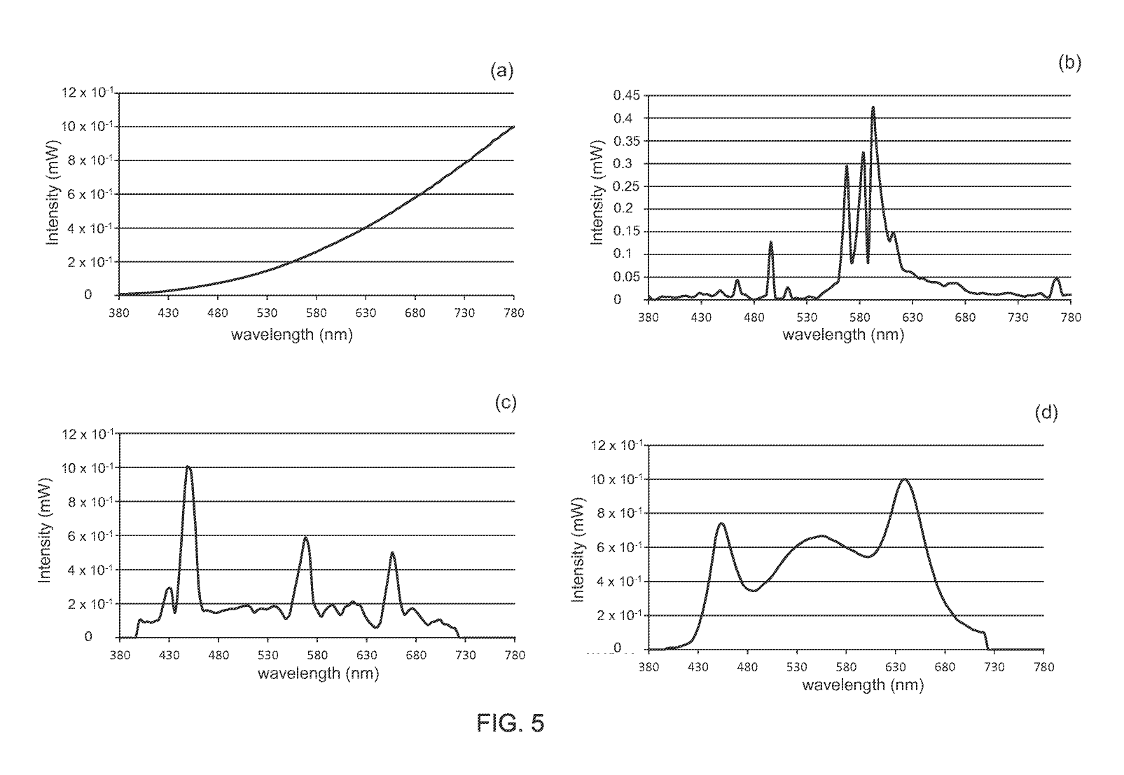

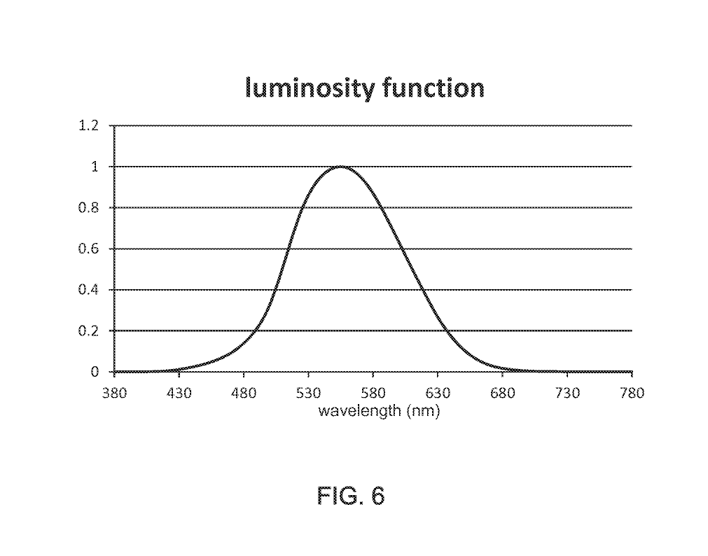

In order to prove the practicability of the light source quality evaluating method by using spectral resemblance with respect to the blackbody radiation, various experiment data will be presented in following paragraphs. Please refer to FIG. 5, there is shown 4 power spectrums of different light sources. In FIG. 5, plots (a), (b), (c), and (d) are power spectrums of an incandescent bulb, a high pressure sodium (HPS) lamp, a fluorescent tube, and a light-emitting diode (LED) device, respectively. Moreover, referring to FIG. 6, which illustrates a diagram of a luminosity function. As shown in FIG. 6, the luminosity function consists of a plurality of visual-sensitivity lights, and the range of the visual-sensitivity wavelengths of the visual-sensitivity lights covers the wavelengths of the incandescent bulb, the HPS lamp, the fluorescent tube, and the LED device.

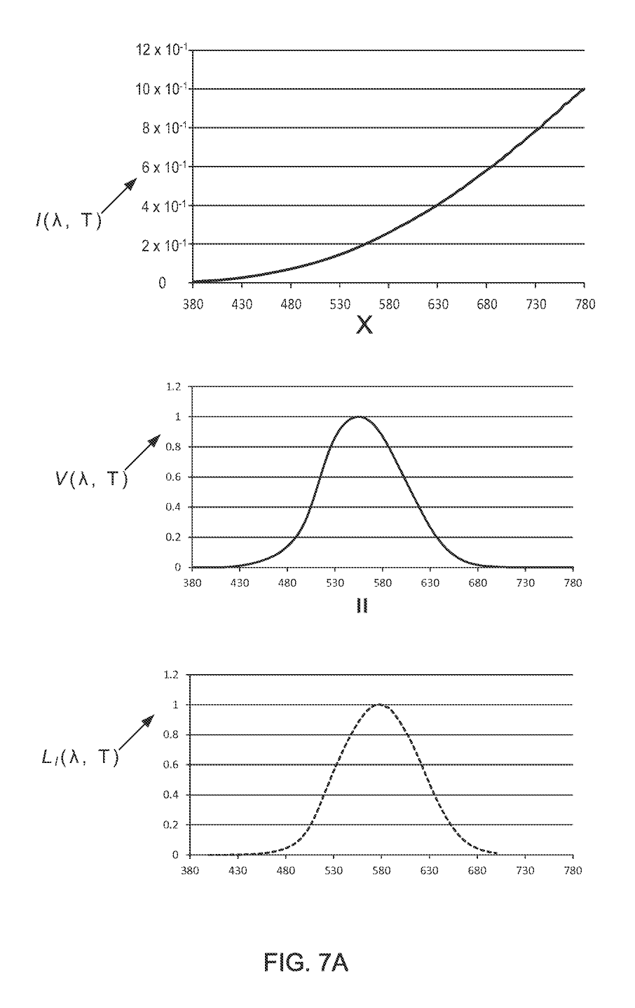

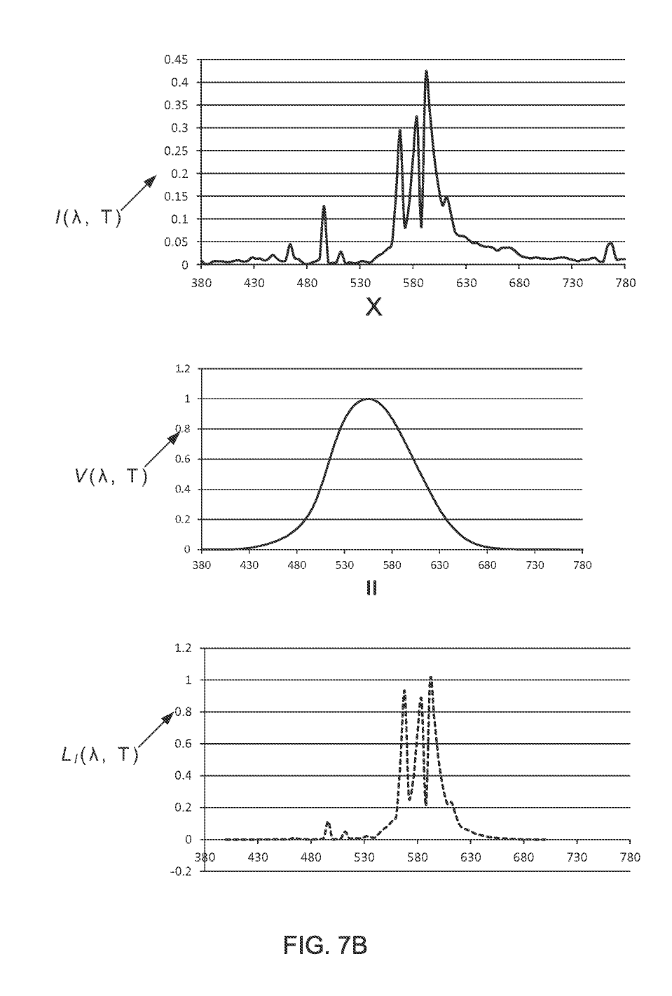

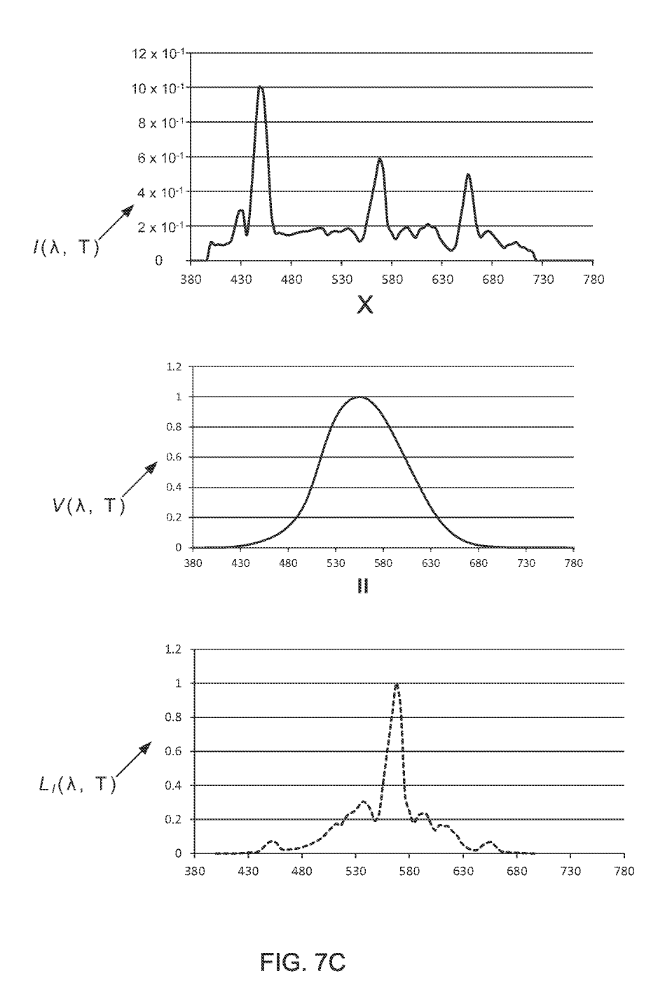

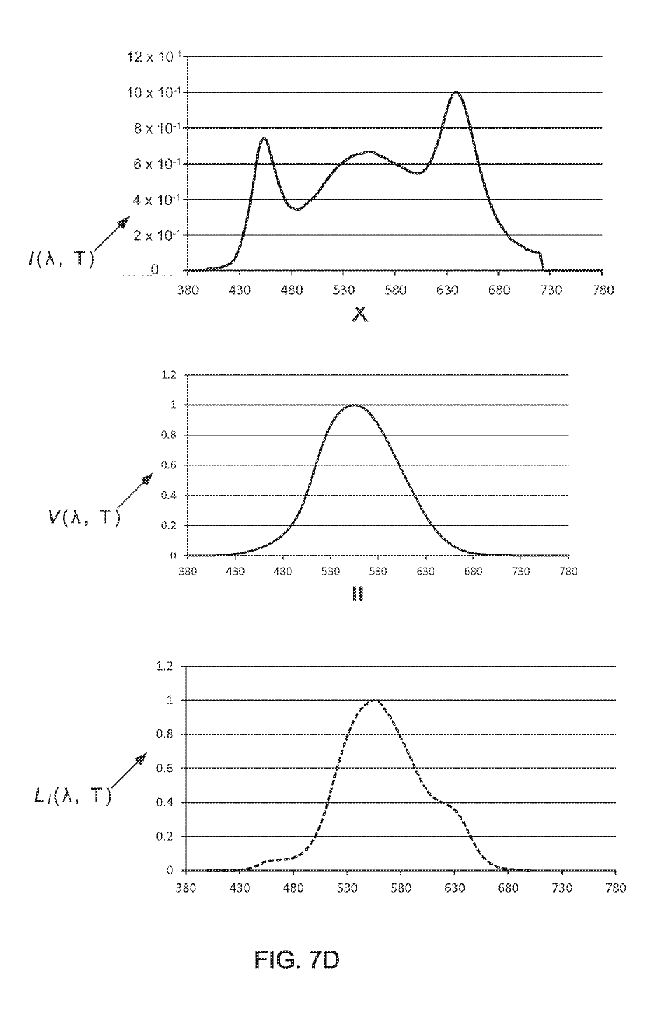

Continuously, please refer to FIG. 7A, FIG. 7B, FIG. 7C, and FIG. 7D, there are shown schematic diagrams of transforming the power spectrum to the luminance spectrum of incandescent bulb, HPS lamp, fluorescent tube, and LED device, respectively. As shown in FIG. 7A, after the power spectrum of incandescent bulb and the luminosity function are obtained, the luminance spectrum of incandescent bulb can be derived and plotted by way of multiplying the power spectrum by the luminosity function. Similarly, as shown in FIG. 7B-FIG. 7C, the luminance spectrums of HPS lamp, fluorescent tube, and LED device are also derived and plotted.

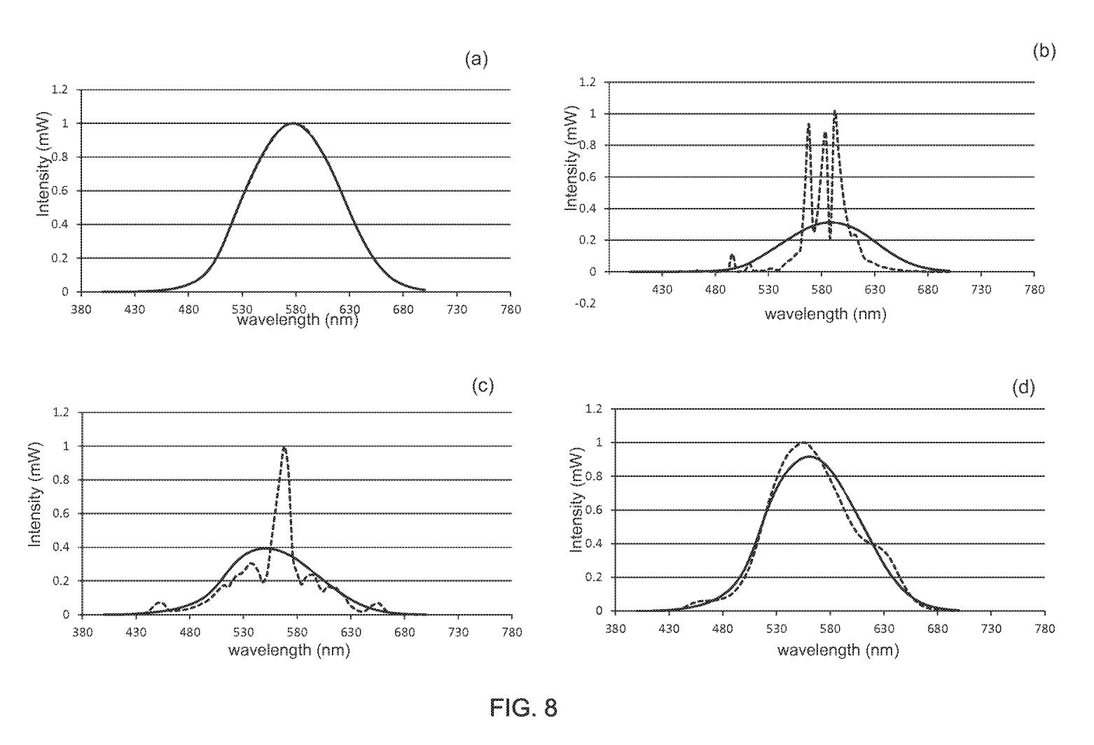

Eventually, please refer to FIG. 8, there are shown schematic comparison diagrams of luminance spectrum of incandescent bulb, HPS lamp, fluorescent tube, and LED device and the corresponding luminance spectrum of blackbody radiation thereof. As shown in plot (a) of FIG. 8, an index of spectral resemblance with respect to the blackbody-radiation (SR_{BR}) of the incandescent bulb is calculated by way of calculating an overlapped area between the luminance spectrum of and the corresponding luminance spectrum of blackbody radiation and dividing the overlapped area by the area of the luminance spectrum of blackbody radiation. Similarly, as shown in plots (b)-(c), the SR_{BR} of the HPS lamp, the fluorescent tube, and the LED device are also calculated.

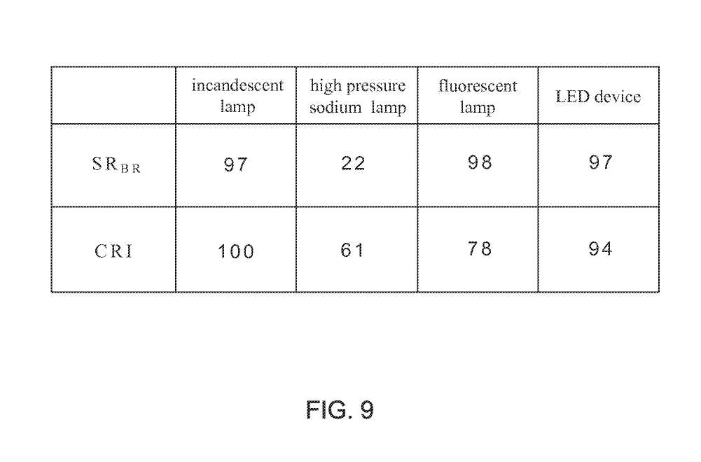

Furthermore, please refer to FIG. 9, which illustrates a statistical table of the SR_{BR} of the incandescent bulb, the HPS lamp, the fluorescent tube, and the LED device. As shown in FIG. 9, the CRI of the incandescent bulb, the HPS lamp, the fluorescent tube, and the LED device are respectively 100, 61, 78, and 94; however, the SR_{BR} of the incandescent bulb, the HPS lamp, the fluorescent tube, and the LED device are respectively 97, 22, 98, and 97. Therefore, form the statistical table, it can find that the incandescent bulb's CRI is very close to its SR_{BR}; however, there has a large difference between the HPS lamp's CRI and SR_{BR}.

Thus, through the descriptions, the light source quality evaluating method by using spectral resemblance with respect to the blackbody radiation of the present invention has been completely introduced and disclosed; Moreover, the practicability and the technology feature have also been proven by various experiment data. So that, in summary, the present invention has the following advantages: this method is used for evaluating the quality of light based on physiological perception of human. In evaluating operation, the method firstly transfers a power spectrum of a light source to a luminance spectrum of light source through a luminosity function; next, the method compares the luminance spectrum of light source with a luminance spectrum of the blackbody radiation thereof. Therefore, an index of spectral resemblance with respect to the black body radiation (SR_{BR}) would be calculated and then obtained, such that the SR_{BR} can be used for evaluating the quality of the light source. Moreover, comparing to conventional color rendering index (CRI), SR_{BR} is a better light source quality evaluating method because of having fairness and consistency.

The above description is made on embodiments of the present invention. However, the embodiments are not intended to limit scope of the present invention, and all equivalent implementations or alterations within the spirit of the present invention still fall within the scope of the present invention.

What is claimed is:

1. A light source quality evaluating method by using spectral resemblance with respect to the blackbody radiation, comprising the steps of:
(1) measuring a spectrum and a color temperature of a light;
(2) calculating a corresponding luminance spectrum of blackbody radiation according to the color temperature;
(3) providing a luminosity function;
(4) multiplying the spectrum measured in the step (1) by the luminosity function, so as to transform the spectrum to a luminance spectrum of the light; and
(5) comparing the luminance spectrum of the light with the corresponding luminance spectrum of blackbody radiation, so as to obtain an index of spectral resemblance with respect to the blackbody-radiation (SR_{BR}).

2. The light source quality evaluating method of claim 1, wherein the spectrum of the light measured by the step (1) is a power spectrum.

3. The light source quality evaluating method of claim 1, wherein the step (3) further comprises the detailed steps of:
(31) providing a reference light having a reference wavelength and a reference power intensity;
(32) getting one visual-sensitivity light having a visual-sensitivity wavelength and a visual-sensitivity power intensity from a plurality of visual-sensitivity lights, wherein the visual sensitivity on people eyes of the visual-sensitivity light is the same as the reference light;
(33) dividing the reference power intensity by the visual-sensitivity power intensity, so as to obtain a visual-sensitivity intensity according to the visual-sensitivity wavelength;
(34) determining whether all the visual-sensitivity intensities according to each of the visual-sensitivity wavelengths are obtained, if yes, proceeding to step (36), otherwise, proceeding to step (35);
(35) repeating the step (32) and the step (33); and
(36) taking the visual-sensitivity wavelengths as a plurality of X coordinates, and taking the visual-sensitivity intensities as a plurality of Y coordinates, so as to derive and plot the luminosity function.

4. The light source quality evaluating method of claim 3, wherein the step (4) further comprises the detailed steps of:
(41) analyzing a plurality of wavelength values of the power spectrum and a plurality of power intensities according to the wavelength values;
(42) finding the visual-sensitivity wavelengths from the luminosity function, wherein the values of the found visual-sensitivity wavelengths are correspondent with the wavelength values, respectively;
(43) finding the visual-sensitivity intensities of the visual-sensitivity wavelengths from the luminosity function;
(44) respectively multiplying the visual-sensitivity intensities by the power intensities of the step (41), so as to obtain a plurality of luminance values; and
(45) taking the wavelength values of the step (41) as a plurality of X coordinates, and taking the luminance values of the step (44) as a plurality of Y coordinates, so as to derive and plot the luminance spectrum of light.

5. The light source quality evaluating method of claim 1, wherein the light-emitting device is selected from the group consisting of: incandescent bulb, high pressure sodium (HPS) lamp, fluorescent lamp, light-emitting diode (LED) device, organic light-emitting diode (OLED) device, polymer light-emitting diode (PLED) lamp, and candle.

6. The light source quality evaluating method of claim 1, wherein the corresponding luminance spectrum of blackbody radiation in the step (2) is calculated by using the Planck's law.

7. The light source quality evaluating method of claim 3, wherein the reference light is a green light with the reference wavelengths of 555 nm.

8. The light source quality evaluating method of claim 3, wherein the step (5) further comprises the detailed steps of:
(51) overlapping the luminance spectrum of the light with the corresponding luminance spectrum of blackbody radiation;
(52) calculating an overlapped area between the luminance spectrum of the light and the corresponding luminance spectrum of blackbody radiation; and
(53) dividing the overlapped area by the area of the corresponding luminance spectrum of blackbody radiation, so as to obtain the index of spectral resemblance with respect to the blackbody-radiation (SR_{BR}).
